(19) United States
(12) Patent Application Publication
(10) Pub. No.: US 2008/0274400 A1
(43) Pub. Date: Nov. 6, 2008

(54) BATTERY CELL HAVING ENERGY CONTROL DEVICE

(76) Inventors: Jeff Dixon, Indianapolis, IN (US); Chad Hartzog, Kokomo, IN (US); Hiroyuki Yumoto, Fishers, IN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/769,967

(22) Filed: Jun. 28, 2007

Related U.S. Application Data
(60) Provisional application No. 60/806,050, filed on Jun. 28, 2006.

(51) Int. Cl. H01M 6/42

(52) U.S. Cl. 429/150

(57) ABSTRACT

A battery assembly includes a plurality of battery cells. Each cell includes a plurality of first electrodes and second electrodes. First and second insulators extend over the first and second electrodes. An envelope or shell extends over the first and second insulators thereby encapsulating the first and second insulators. A lithium energy control electronics device (the LEC) is disposed, i.e. integrated inside the shell of each cell of the battery assembly. Each cell of the battery assembly is electronically and operatively communicated with one another through the respective LEC disposed inside each cell.

### RELATED APPLICATIONS

This non-provisional application claims priority to a provisional application Ser. No. 60/806,050 filed on Jun. 28, 2006 and incorporated by reference herein in its entirety.

### FIELD OF THE INVENTION

The subject invention relates to battery packs, and more particularly to a battery cell of the battery pack.

### BACKGROUND OF THE INVENTION

Motor vehicles, such as, for example, hybrid vehicles use multiple propulsion systems to provide motive power. This hybrid vehicles recharge their batteries by capturing kinetic energy via regenerative braking. When cruising or idling, some of the output of the combustion engine is fed to a generator (merely the electric motor(s) running in generator mode), which produces electricity to charge the batteries. This contrasts with all-electric cars which use batteries charged by an external source such as the grid, or a range extending trailer. Nearly all hybrid vehicles still require gasoline as their sole fuel source though diesel and other fuels such as ethanol or plant based oils have also seen occasional use.

Batteries and cells are important energy storage devices and are well known in the art. The batteries and cells typically comprise electrodes and an ion conducting electrolyte positioned therebetween. For example, the rechargeable lithium ion cell, typically comprises essentially two electrodes, an anode and a cathode, and a non-aqueous lithium ion conducting electrolyte therebetween. The anode (negative electrode) is a carbonaceous electrode that is capable of intercalating lithium ions. The cathode (positive electrode), a lithium retentive electrode, is also capable of intercalating lithium ions. The carbon anode comprises any of the various types of carbon (e.g., graphite, coke, carbon fiber, etc.) which are capable of reversibly storing lithium species, and which are bonded to an electrochemically conductive current collector (e.g., copper foil) by means of a suitable organic binder (e.g., polyvinylidine fluoride, PVdF).

Due to the different charging characteristics of such batteries, different battery chargers are required. For example, lithium ion batteries require constant current charging up to a certain voltage value and constant voltage charging thereafter. This constant current charging however may create what is referred to an overcharge condition. One characteristic, however, of lithium chemistry batteries is that it has less tolerance to overcharging than other battery technologies. Excessive voltage may damage the active materials. In addition, overheating may occur as a result of prolonged overcharging of a battery causing the temperature of the battery to increase to an unacceptable level, possibly causing damage.

To address this problem, various prior art battery protection circuits have been developed that limit charging to reduce the possibility of overheating of the battery cell. For example, a thermal protection circuit will disable the battery charging system when a maximum, threshold temperature is reached. Thermal detection is not a likely candidate for lithium batteries however, because heat generated by charging lithium batteries may follow overcharge, rather than heat generation preceding the overcharge. Therefore, a thermal protection circuit for a lithium battery is unpredictable and unreliable.

Another overcharge protection alternative is to utilize software based systems to limit charging times to reduce the possibility of overheating of a battery pack. These software systems monitor the battery pack voltage level and terminate fast charging when the battery pack reaches a preselected voltage level, for example 80 percent of the desired voltage level. Once the battery reaches this preselected level (percentage) of the desired voltage, rapid charging is terminated and a timer is enabled that allows trickle charging for a fixed period of time.

There are disadvantages to this approach. For example, such software systems are unreliable as inaccurate readings can sometimes occur. Alluding to the above, the aforementioned prior art designs fail to provide an important backup protection mechanism where a primary control, for example, a battery control unit (BCU), fails to control the charging as desired and are too complex and bulky in its form thereby negatively affecting packaging characteristics of the battery cell and packs in general

As such, there is a constant need in the area of the battery art for an improved design of a battery pack having effective functional and packaging characteristics, structural integrity thereby eliminating problems associated with current designs of prior art battery cells and packs.

### SUMMARY OF THE INVENTION

A battery assembly or pack of the present invention is adaptable to be utilized in various configurations including and not limited to an overlapping battery cell packaging configuration and a vertical stack battery cell packaging configuration. The battery pack includes a plurality of cells. Each cell is further defined by a housing presenting an envelope of a rectangular configuration having a negative terminal and a positive terminal opposed the negative terminal and spaced by side edges. Each positive and negative terminals define at least one opening extending therein. Each cell includes a plurality of electrodes of opposite charges disposed therein for conducting electrolyte therebetween. Preferably, these plurality of electrodes are further defined by a first electrode adjacent a first current collector and a second electrode of charge opposite from the first electrode and adjacent a second current collector and a separator layer positioned between the first and second electrodes. A device, such as, for example Lithium Energy Control unit (the LEC) is integral with each of the cells and is adaptable for independently controlling operational mode of the cell with each of the cells operably communicating with one another through the respective devices. The device is further defined by a board disposed inside the housing. The board extends along one of the side edges and between the positive and negative terminals. The device includes a charge controller and a memory unit having pre-programmed instructions stored therein. The charge controller and the memory are connected to the board. A central processing unit is connected to the board to operably communicate with the charge controller and the memory for executing the pre-programmed instructions thereby balancing the electrodes of the cell.

An advantage of the present invention is to provide a battery assembly having efficient packaging characteristics by integrating a device (the LEC) in each cell.

Another advantage of the present invention is to provide a battery assembly that reduces the weight by eliminating connecting hardware.

Still another advantage of the present invention is to provide a battery assembly that reduces manufacturing costs due to simplified assembly pattern

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of a battery pack having a plurality of cell stacks with each cell having Lithium Energy Control device (the LEC) integrated therein;

FIG. 2 is a front view of the cell illustrating the LEC as shown in phantom;

FIG. 3 illustrates a front view of an alternative embodiment of the cell of FIG. 2;

FIG. 4 illustrates a fragmental view of the cell having the LEC (shown in phantom) integrated therein;

FIG. 5 is a cross sectional view of FIG. 2;

FIG. 6 is a cross sectional view of FIG. 3;

FIG. 7 is a schematic view of a battery cell system; and

FIG. 8 is another schematic view of a system interface of the battery cell system of FIG. 7.

### DETAILED DESCRIPTION OF THE PREFERRED EMBODIMENT

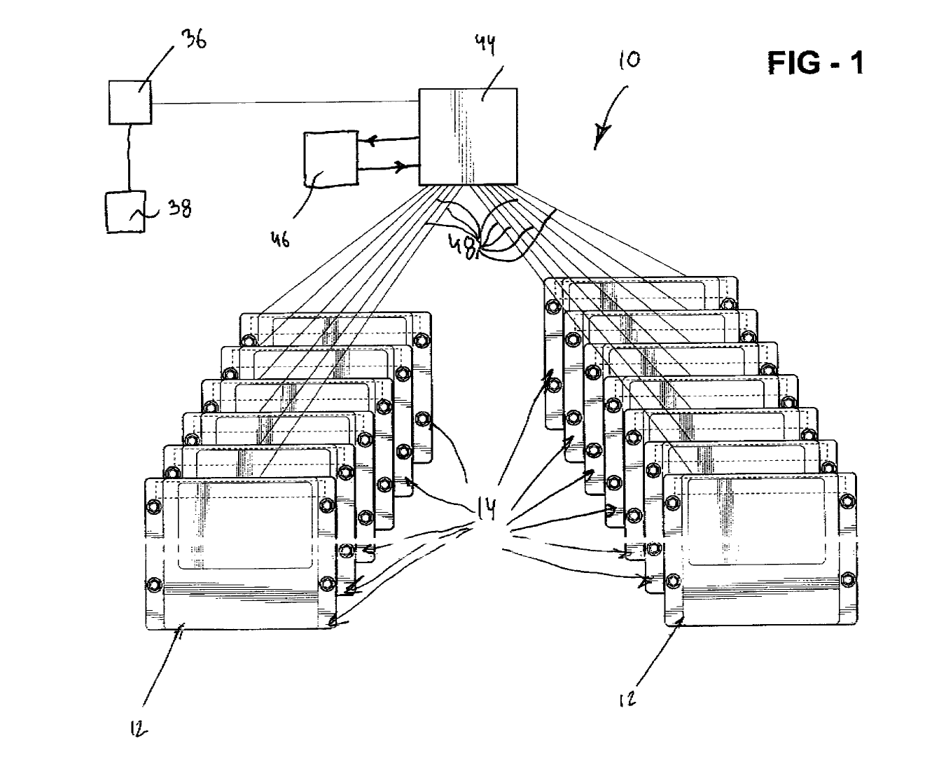

Referring to the Figures, wherein like numerals indicate like or corresponding parts, a battery assembly or a battery pack of the present invention is generally shown at 10. Preferably, the battery pack 10 includes several rows, generally indicated at 12, (only two shown in FIG. 1 for illustrative purposes without limiting the scope of the present invention) of battery cells (the cell), generally indicated at 14 and interconnected with one another in the pattern known to those skilled in the battery art. The battery pack 10 of the present invention is adaptable to be utilized in various configurations including and not limited to an overlapping battery cell packaging configuration, a vertical stack battery cell packaging configuration, and other configurations without limiting the scope of the present invention.

Each cell 14 includes a plurality of battery core components co-acting between one and the other to conduct electrolyte therebetween as known to those skilled in the battery art. A plurality of first electrodes, i.e. cathodes are positioned adjacent a first current collector (not shown) and a plurality of second electrodes, i.e. anodes are adjacent a second current collector (not shown). A separator layer (not shown) is positioned between the first and second electrodes with the first and second electrodes conducting electrolyte therebetween.

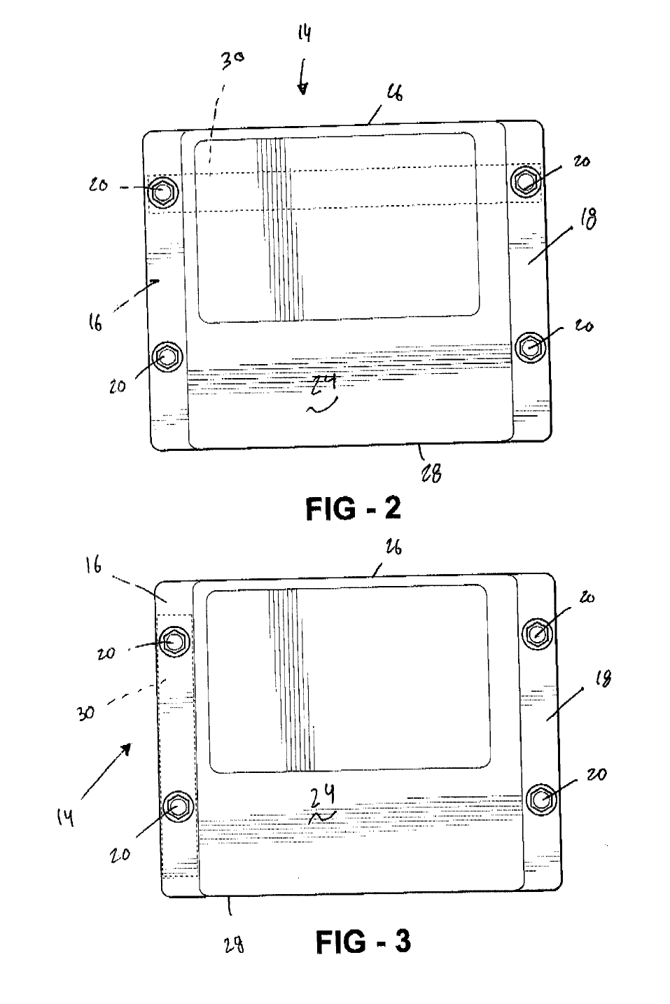

As best illustrated in FIGS. 2 and 3, each battery cell 14 presents at least one positive terminal lip 16 and at least one negative terminal lip 18. At least two electrical contacts 20 are provided for each polar contact to divide the current carrying capacity and to provide auxiliary paths for current flow in the event that one or more contacts would develop high resistance or electrically open. Each contact is further defined by an aperture or opening 22 defined in each terminal lip 16 and 18 includes extending therethrough to provide the means to guide the cells 14 over electrical studs or tie rods.

As illustrated in FIG. 2 through 6, each cell 14 includes a shell or packaging envelope 24 having a generally rectangular configuration and has side edges 26 and 28 spaced by the aforementioned positive and negative terminal lips 16 and 18. The shell 24 is formed from a sheet of packaging material, such as aluminum, which is placed under the aforementioned cell components and a remaining part of the packaging envelope is folded over the battery core components to form the aforementioned shell 24. Those skilled in the lithium battery art will appreciate that the shell 24 may also be fabricated from any other suitable materials without limiting functional characteristics of the present invention.

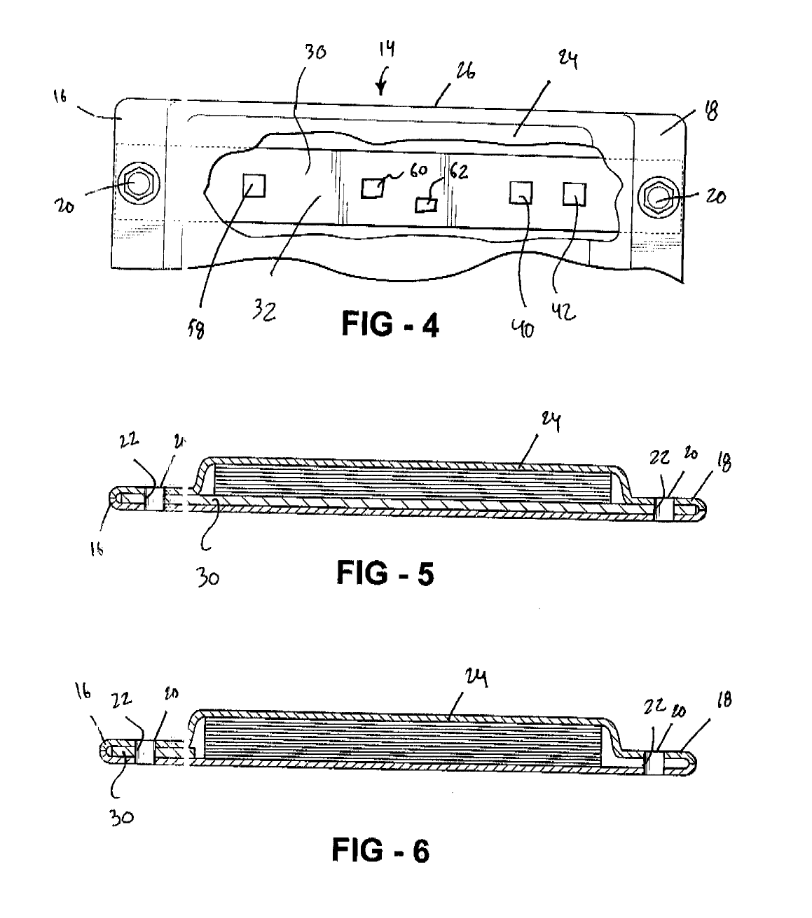

To eliminate one or more problems associated with the prior art designs each cell 14 is equipped with a device 30, i.e. Lithium Energy Control electronics device (the LEC) integrally incorporated therein for independently controlling operational mode of the cell 14 as each cell 14 operably communicates with one another through the device 30. As best shown in FIG. 4, the device 30 is further defined by a board or plate 32 having a plurality of battery control unit components incorporated therein. The board 32 is located inside the envelope or shell 24 and extends along the side edge 26 or 28 and between the positive and negative terminals or lips 16 and 18, as best shown in FIGS. 2 and 4. This layout of the board 32 relative to the envelope 24 is not intended to limit the scope of the present invention. The board 32 may be disposed inside any of the positive and/or negative terminals or lips 16 and 18, as shown in phantom in FIG. 3 or in the middle of the envelope 24 (not illustrated), as long as the device 30 is integrally sealed inside the cell 14.

Alternatively, the cell 14 is configured to be adaptable to remove and replace the board 32 when required. Those skilled in the battery art will appreciate that the cells 14 are configured to produce electrical power, and are also configured to be rechargeable, for example by receiving conventional electrical current, which is monitored by current sensor (not shown). The recharging current may be from either charger or from a machine 36, as shown in FIG. 1, operating as a generator. A voltage sensor 38 is configured to detect a voltage level and produce a voltage indicative signal representative of the detected voltage. In one embodiment, one voltage sensor 38 is provided to detect the overall output voltage of the combination of the cells 14. However, in an alternate embodiment, sensor may comprise a plurality of sensors 40 and 42, as shown in FIG. 4, for each cell 14, and provide a corresponding plurality of voltage indicative signals.

In the present invention, the information gathered by the cell monitor could be communicated to a common point 44 and then relayed to a vehicle controller 46 with calculated data, as shown in FIG. 1 as a functional representation. FIG. 1 could also be seen as an embodiment where each cell 14 is wired 48 to the common point 44. Further the information could be relayed by the individual cells 14 around to the main controller in a circular pattern, often called a daisy chain. A further embodiment (not shown) could utilize a wireless technique such as blue tooth, wi-fi, RFID, or various other forms of wireless communication technologies, without limiting the scope of the present invention.

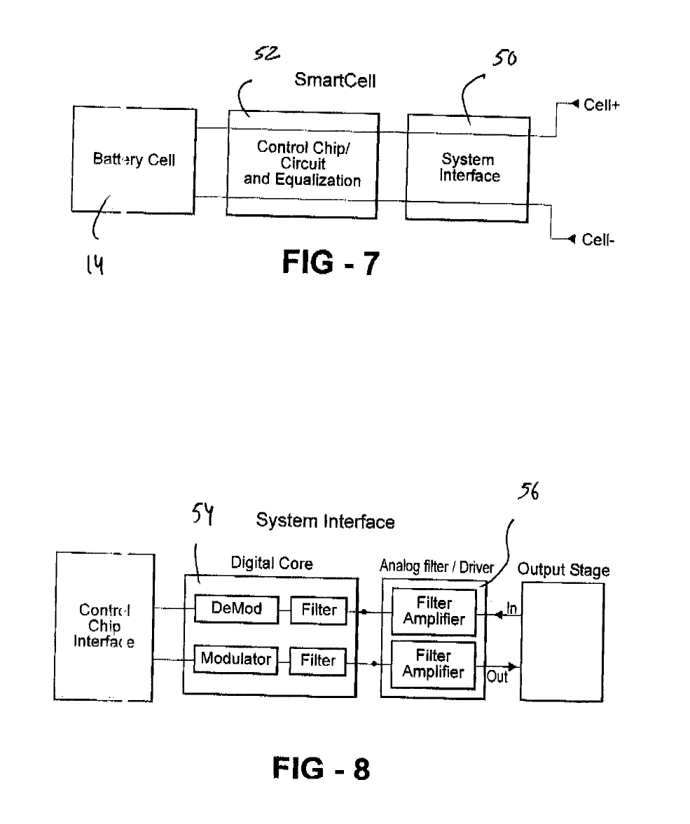

A further embodiment would be the use of a power line carrier technology similar to those used in home and building automation. A further embodiment would be the utilization of an inductive pickup communication device as is commonly used in the medical industry for communication to implanted devices. The functional embodiments of all of these devices are illustrated in FIGS. 7 and 8.

As shown in FIG. 7, the measurement device and interfaces are located within cell + and cell −, wherein the cell 14 includes one or more cells in series, and one or more cells in parallel. A system interface 50 presents a direct wire, wireless, inductive, or power line carrier and is operatively communicated with the cell 14 through a control chip/circuit and equalization device 52. FIG. 8 shows a detailed view of the system interface 50. The cell level control is passed through a digital core 54 for the purpose of modulation and demodulation. These terms are generally used in communication systems and denote a formatting of information into another media. FIG. 8 also represents the embodiment of the RF modulator where the data is converted to Radio Frequencies for communication. The analog filter/driver 56 is again a standard represents pre and post filtering required to interface to an output stage. The filter portion could also be integrated into some type of DSP (Digital Signal Processor) or other Digital processing core. The output stage is a representation of some type of connection method. In the case of the wireless embodiment, this would be a type of antenna. For the power line carrier, this would be an isolated connection to a power buss, or to either cell positive or cell negative.

The device 30 is configured for controlling the overall operation of each individual cell 14, including the charging/recharging operation as well as any adjustments to a pre-determined charging strategy associated with the battery pack 10. This inventive design allows each individual cell 14 to operate independently from one another and acting in accord when required by the operational application. The design of the present invention eliminates the need for prior art battery control unit acting as a central operational component connected to each cell 14, that is bulky and not effective in modern automotive applications and which dramatically affects packaging characteristics of the battery pack 10.

Alluding to the above, the device 30, as best illustrated in FIG. 4, includes a charge controller 58, a memory 60, and a central processing unit (CPU) 62. The CPU 62 may comprise conventional processing apparatus known in the art, capable of executing preprogrammed instructions stored in a memory (not shown) coupled to the CPU 62, and may comprise conventional memory devices, for example, a suitable combination of volatile, and non-volatile memory so that a main line software routine can be stored and yet allow further processing of dynamically produced data and/or signals. The charge controller 58 is also coupled to the CPU 62, and to protection circuit. The charge controller 58 is configured so as to allow the CPU 62 to set a charge termination voltage such that when the actual voltage level from the battery pack 10 exceeds the set charge termination voltage wherein a charge termination control signal is generated on line. The charge controller 58 may be configured as a separate unit or circuit, as illustrated, or may be implemented in software executed on the CPU 62. The charge controller 58 is further configured to provide threshold voltage levels to protection circuit, namely, the preselected battery pack threshold Turn-Off level (V.sub.toff) and the preselected battery pack threshold Turn-On level (V.sub.ton). This two voltage levels establish a hysteresis band in which the battery pack output voltage level is controlled, as described more full below.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A battery cell for a battery pack comprising;
a housing,
a plurality of electrodes of opposite charges disposed in said housing for conducting electrolyte therebetween, and
a device integral with said housing for independently controlling operational mode of said battery cell.

2. A battery cell as set forth in claim 1 wherein said device is further defined by a board disposed inside said housing.

3. A battery cell as set forth in claim 2 wherein said device includes a charge controller and a memory unit having preprogrammed instructions stored therein, said charge controller and said memory connected to said board.

4. A battery cell as set forth in claim 3 wherein said device includes a central processing unit connected to said board and operably communicating with said charge controller and said memory for executing said preprogrammed instructions for balancing said electrodes of said battery cell.

5. A battery cell as set forth in claim 4 wherein said plurality of electrodes are further defined by a first electrode adjacent a first current collector and a second electrode of charge opposite from said first electrode and adjacent a second current collector and a separator layer positioned between said first and second electrodes.

6. A battery cell as set forth in claim 5 wherein said housing presents an envelope of a rectangular configuration having a negative terminal and a positive terminal opposed said negative terminal and spaced by side edges with each of said positive and negative terminals defining at least one opening.

7. A battery cell as set forth in claim 6 wherein said board extends inside said envelope and along one of said side edges and between said positive and negative terminals.

8. A battery pack comprising;
a pair of cells,
a plurality of electrodes of opposite charges disposed in each of said cells for conducting electrolyte therebetween, and
a device integral with each of said cells for independently controlling operational mode of said cell with each of said cells operably communicating with one another through said devices.

9. A battery pack as set forth in claim 8 wherein said cell is further defined by a housing presenting a rectangular configuration having a negative terminal and a positive terminal opposed said negative terminal and spaced by side edges with each of said positive and negative terminals defining at least one opening therein.

10. A battery pack as set forth in claim 9 wherein said device is further defined by a board disposed inside said housing, said board extending along one of said side edges and between said positive and negative terminals.

11. A battery pack as set forth in claim 10 wherein said device includes a charge controller and a memory unit having preprogrammed instructions stored therein, said charge controller and said memory connected to said board.

12. A battery pack as set forth in claim 11 wherein said device includes a central processing unit connected to said board and operably communicating with said charge controller and said memory for executing said preprogrammed instructions thereby balancing said electrodes of said cell.

13. A battery pack as set forth in claim 12 wherein said plurality of electrodes are further defined by a first electrode adjacent a first current collector and a second electrode of charge opposite from said first electrode and adjacent a second current collector and a separator layer positioned between said first and second electrodes.
